(19) United States
(12) Patent Application Publication
(10) Pub. No.: US 2026/0287990 A1
(43) Pub. Date: Sep. 24, 2026

(54) SEALED PROJECTION DEVICE

(71) Applicants: K-Tronics (Suzhou) Technology Co., Ltd., Suzhou, Jiangsu (CN); BOE Technology Group Co., Ltd., Beijing (CN)

(72) Inventors: Qingliu HU, Beijing (CN); Lugui CUI, Beijing (CN); Hunghuei HSU, Beijing (CN); Hongfei QIAN, Beijing (CN); Xiaoli XIA, Beijing (CN)

(21) Appl. No.: 19/477,450

(22) PCT Filed: Mar. 14, 2024
(86) PCT No.: PCT/CN2024/081665

§ 371 Date: Oct. 21, 2025

(30) Foreign Application Priority Data
Apr. 26, 2023 (CN) 202310465102.X

(51) Int. Cl. G03B 21/16; G02B 3/08; G02B 5/08; G03B 21/00; G03B 21/14; G03B 21/20

(52) U.S. Cl. CPC G03B 21/16; G02B 3/08; G02B 5/0858; G03B 21/006; G03B 21/145; G03B 21/2066; G03B 21/208

(57) ABSTRACT

Provided is a sealed projection device. The sealed projection device includes a housing, a light source assembly, a first reflector, a spatial light modulator, and a lens assembly, wherein the light source assembly, the first reflector, the spatial light modulator, and the lens assembly are all disposed inside the housing, and the first reflector, the spatial light modulator, and the lens assembly are sequentially disposed on a propagation path of a light beam emitted by the light source assembly; and the first reflector includes a substrate and a reflective film that are stacked, with thermal conductivity of the substrate being greater than thermal conductivity of glass.

### CROSS-REFERENCE TO RELATED APPLICATIONS

The present disclosure is a U.S. national phase application based on PCT/CN2024/081665, filed on Mar. 14, 2024, which claims priority to Chinese Patent Application No. 202310465102.X, filed on Apr. 26, 2023, and entitled “SEALED PROJECTION DEVICE”, both of which are incorporated by reference herein.

### TECHNICAL FIELD

Embodiments of the present disclosure relate to the field of display technologies, and in particular, relate to a sealed projection device.

### BACKGROUND

A sealed projection device has advantages such as small size and portability. In addition, the probability of dust and other impurities entering the sealed projection device is low, which has little impact on the projection effect, and thus sealed projection devices are widely used.

### SUMMARY

Embodiments of the present disclosure provide a sealed projection devices. The technical solutions are as follows.

In one aspect, a sealed projection device is provided. The sealed projection device includes a housing, a light source assembly, a first reflector, a spatial light modulator, and a lens assembly, wherein the light source assembly, the first reflector, the spatial light modulator, and the lens assembly are all disposed inside the housing, and the first reflector, the spatial light modulator, and the lens assembly are sequentially disposed on a propagation path of a light beam emitted by the light source assembly; and the first reflector includes a substrate and a reflective film that are stacked, with thermal conductivity of the substrate being greater than thermal conductivity of glass.

In some embodiments, the substrate is made of a metal material or a graphene material.

In some embodiments, the metal material is steel, aluminum, or copper.

In some embodiments, a thickness of the substrate is 0.3 mm to 2.2 mm.

In some embodiments, the reflective film includes a plurality of dielectric layers stacked in sequence, wherein the plurality of dielectric layers include a first dielectric layer and a second dielectric layer, a refractive index of the first dielectric layer being different from a refractive index of the second dielectric layer.

In some embodiments, a thickness of the reflective film is 60 μm to 120 μm.

In some embodiments, the first reflector further includes a connection layer, the connection layer being disposed between the substrate and the reflective film.

In some embodiments, the connection layer is environmentally friendly grease or thermally conductive silicone grease.

In some embodiments, the spatial light modulator includes a liquid crystal display panel.

In some embodiments, the sealed projection device further includes a first Fresnel lens and a second Fresnel lens, wherein the first Fresnel lens and the second Fresnel lens are respectively disposed on both sides of the spatial light modulator along the propagation path.

In some embodiments, the sealed projection device further includes a thermal insulation layer, wherein the thermal insulation layer is disposed between the spatial light modulator and the first Fresnel lens, and the first Fresnel lens is disposed on one side, proximal to the first reflector, of the spatial light modulator.

In some embodiments, the thermal insulation layer includes a glass substrate and at least one thermal insulation film, wherein the at least one thermal insulation film is disposed on one side, distal to the spatial light modulator, of the glass substrate.

In some embodiments, the thermal insulation film is made of a metal material, an alloy material, or a metal compound material.

In some embodiments, the light source assembly includes a light-emitting device and a condensing element, wherein the condensing element is configured to converge light emitted by the light-emitting device.

In some embodiments, the sealed projection device further includes a second reflector, wherein the second reflector is configured to reflect light emitted from the spatial light modulator to the lens assembly.

### BRIEF DESCRIPTION OF DRAWINGS

For clearer descriptions of the technical solutions according to the embodiments of the present disclosure, the drawings to be referred to for the description of the embodiments are briefly introduced below. Apparently, the drawings in the description below merely illustrate some embodiments of the present disclosure, and those skilled in the art may also derive other drawings according to the drawings without creative efforts.

FIG. 1 is a schematic structural diagram of a sealed projection device according to some embodiments of the present disclosure;

FIG. 2 is a schematic structural diagram of a first reflector according to some embodiments of the present disclosure;

FIG. 3 is a schematic diagram of temperature variation of reflectors made of different materials under equal thermal input power, according to some embodiments of the present disclosure;

FIG. 4 is a simulation diagram of heat accumulation of a glass plate and aluminum plates of different thicknesses, according to some embodiments of the present disclosure;

FIG. 5 is a schematic structural diagram of a thermal insulation layer according to some embodiments of the present disclosure;

FIG. 6 illustrates temperature-operating time curves at a first Fresnel lens and at a liquid crystal display panel when a steel substrate with a reflective film and a glass reflector are each used as a first reflector, according to some embodiments of the present disclosure; and

FIG. 7 is a measurement result diagram of color coordinates and color temperatures of a sealed projection device when a first reflector is made of different materials, according to some embodiments of the present disclosure.

Reference numerals:

1. Housing
2. Light source assembly 21. Light-emitting device 22. Condensing
element
3. First reflector 31. Substrate 32. Reflective film 320. Dielectric layer 33.
Connection layer
4. Spatial light modulator 5. Lens assembly
6. Second reflector 7. First Fresnel lens
8. Second Fresnel lens 9. Thermal insulation layer 91. Glass substrate
92. Thermal insulation film

### DETAILED DESCRIPTION

For clearer descriptions of the objectives, technical solutions, and advantages of the present disclosure, embodiments of the present disclosure are further described in detail hereinafter with reference to the accompanying drawings.

Terms used in the detailed description of the present disclosure are defined merely to explain the embodiments of the present disclosure and are not intended to limit the present disclosure. Unless otherwise defined, technical or scientific terms used in the detailed description of the present disclosure should have the ordinary meanings as understood by those of ordinary skill in the art to which the present disclosure belongs. The terms “first,” “second,” “third,” and other similar words, as used in the specification and in the claims of the patent application of the present disclosure, do not indicate any order, quantity, or importance, but are merely defined to distinguish different components. Likewise, the terms “a,” “an,” or other similar words do not indicate a limitation of quantity, but rather the presence of at least one. The terms “include,” “comprise,” or other similar words indicate that the elements or objects stated before “include” or “comprise” encompass the elements or objects and equivalents thereof listed after “include” or “comprise”, but do not exclude other elements or objects.

In the related art, a sealed projection device includes a housing, a light source assembly, a first reflector, a spatial light modulator, and a lens assembly. The light source assembly, the first reflector, the spatial light modulator, and the lens assembly are all disposed inside the housing, and the first reflector, the spatial light modulator, and the lens assembly are sequentially disposed along a propagation path of a light beam emitted by the light source assembly. The light source assembly is also a heat source. The higher the brightness of the light source, the more heat is generated, resulting in a higher temperature inside the sealed projection device, especially in the region enclosed by the light source assembly, the first reflector, and the spatial light modulator. Because glass has a low thermal conductivity, a first reflector made of glass is not conducive to heat dissipation, which tends to cause key optical components, such as the spatial light modulator, to be damaged due to excessively high temperatures, thereby affecting the projection effect.

Therefore, in order to protect key optical components, the related art reduces the brightness of the light source assembly to lower the heat generated by the light source assembly. However, reducing the brightness of the light source assembly affects the overall luminous efficacy of the sealed projection device.

The present disclosure provides a sealed projection device that can alleviate the problem of high temperature in the region enclosed by the light source assembly, the first reflector, and the spatial light modulator, and can also enhance the luminous efficacy of the sealed projection device.

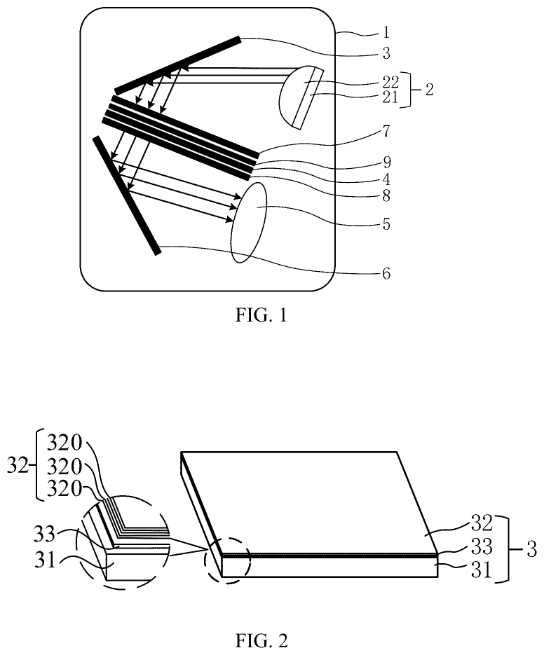

FIG. 1 is a schematic structural diagram of a sealed projection device according to some embodiments of the present disclosure. As illustrated in FIG. 1, the sealed projection device includes a housing 1, a light source assembly 2, a first reflector 3, a spatial light modulator 4, and a lens assembly 5. The light source assembly 2, the first reflector 3, the spatial light modulator 4, and the lens assembly 5 are all disposed within the housing 1, and the first reflector 3, the spatial light modulator 4, and the lens assembly 5 are sequentially disposed along a propagation path of a light beam emitted by the light source assembly 2.

FIG. 2 is a schematic structural diagram of a first reflector according to some embodiments of the present disclosure. As illustrated in FIG. 2, the first reflector 3 includes a substrate 31 and a reflective film 32 that are stacked. The thermal conductivity of the substrate 31 is greater than that of glass.

In the first reflector 3, the reflective film 32 can serve as a reflector, reflecting the light emitted by the light source assembly 2 to the spatial light modulator 4. The substrate 31 of the first reflector 3 can conduct a large amount of heat away from a region enclosed by the light source assembly 2, the first reflector 3, and the spatial light modulator 4, thereby reducing the temperature in the region, alleviating the heat dissipation problem, and protecting the spatial light modulator 4. Since the first reflector 3, which includes the substrate 31, can better alleviate the heat dissipation problem, there is no need to reduce the brightness of the light source to alleviate the heat dissipation problem, thereby increasing the brightness of the light source assembly and enhancing the luminous efficacy of the overall apparatus.

Meanwhile, compared to using other complex heat dissipation structures (e.g., fins) for heat dissipation, alleviating the heat dissipation problem through a substrate with high thermal conductivity is more conducive to reducing the size of the sealed projection device and saving costs. In addition, in the case that the housing is made of non-environmentally friendly materials such as acrylonitrile butadiene styrene (ABS) or plastics, reducing the size of the sealed projection device can decrease the usage of non-environmentally friendly materials, which is more environmentally friendly.

Exemplarily, the substrate 31 is made of a metal material, and the metal material includes steel, aluminum, or copper. Alternatively, the substrate 31 is made of a graphene material. The thermal conductivity of glass is 0.75-1.1 W/(m*K) (watts per meter per kelvin), while the thermal conductivity of a metal material or graphene is higher than that of glass. For example, the thermal conductivity of steel is about 45 W/(m*K), which is about 40 to 60 times that of glass. Since a higher thermal conductivity results in a better heat dissipation effect, a first reflector made using a metal substrate or a graphene substrate can better alleviate the heat dissipation problem.

Exemplarily, the spatial light modulator 4 is a liquid crystal display panel or a micro electro mechanical system (MEMS) mirror.

Exemplarily, the liquid crystal display panel includes an array substrate, a liquid crystal layer, and a color film substrate. The array substrate and the color film substrate are connected opposite to each other, and the liquid crystal layer is disposed between the array substrate and the color film substrate. The light emitted by the light source assembly 2 is reflected by the first reflector 3, and then sequentially passes through the array substrate, the liquid crystal layer, and the color film substrate.

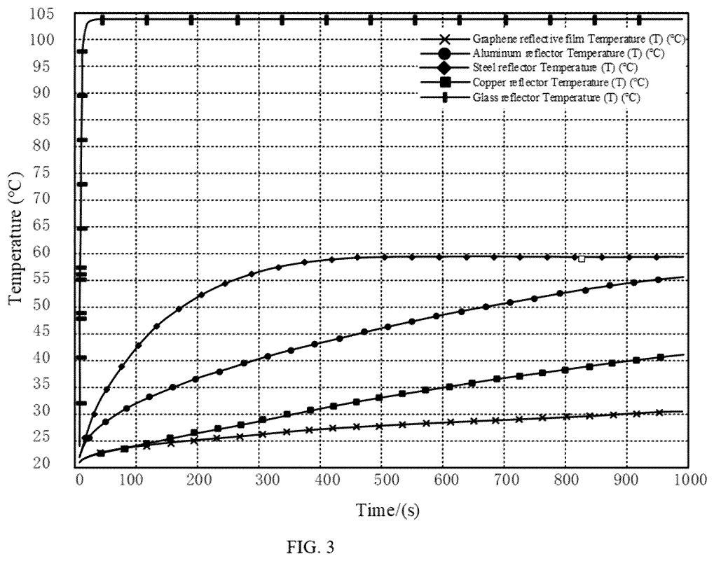

FIG. 3 is a schematic diagram of temperature variation of reflectors made of different materials under equal thermal input power, according to some embodiments of the present disclosure. As illustrated in FIG. 3, under equal thermal input power, the order of temperature rise for reflectors made of graphene, copper, aluminum, steel, and glass materials, from highest to lowest, is glass, steel, aluminum, copper, and graphene. The temperature increase of metal reflectors and the graphene reflector is not significant, indicating that heat is not concentrated on the reflector; whereas the temperature of the reflector made of glass material increases substantially, indicating that heat tends to accumulate in a glass reflector.

After the sealed projection device has been operating for a period of time, for example, after about 16 minutes of operation, the temperature of the glass reflector is the highest at about 103° C.; the actual temperature of the steel reflector is about 59° C.; the actual temperature of the aluminum reflector is about 55° C., which is close to that of the steel reflector; the temperatures of the copper reflector and the graphene reflector are the lowest, which are about 41° C. and 30° C., respectively, exhibiting the best heat dissipation effect. Considering cost factors, it is preferable to use reflectors made of steel or aluminum materials. Considering thickness and hardness factors, that is, between a steel plate and an aluminum plate of the same thickness, the steel plate exhibits greater hardness, or between a steel plate and an aluminum plate with the same hardness, the steel plate is thinner, it is preferable to use a reflector made of steel material. This can ensure the strength of the first reflector and is also conducive to the miniaturization of the sealed projection device, making the sealed projection device more compact and portable.

The heat conduction formula is: q=λ*Δt/d. Where q represents the heat flux density, that is, the amount of heat passing through a unit area per unit time; λ represents the heat transfer coefficient; d represents the heat transfer distance, that is, the thickness; and Δt represents the temperature difference, that is, the temperature difference between both sides of the substrate 31. Therefore, in heat conduction, the amount of conducted heat is inversely proportional to the thickness and directly proportional to the heat transfer coefficient and the temperature difference. However, in practice, because the heat transfer coefficient λ is a function of temperature, the function is generally approximately constant for most materials. In the sealed projection device, since the heat flux density q is a constant value, the temperature difference Δt is in direct proportion to the heat transfer distance (i.e., the thickness) d.

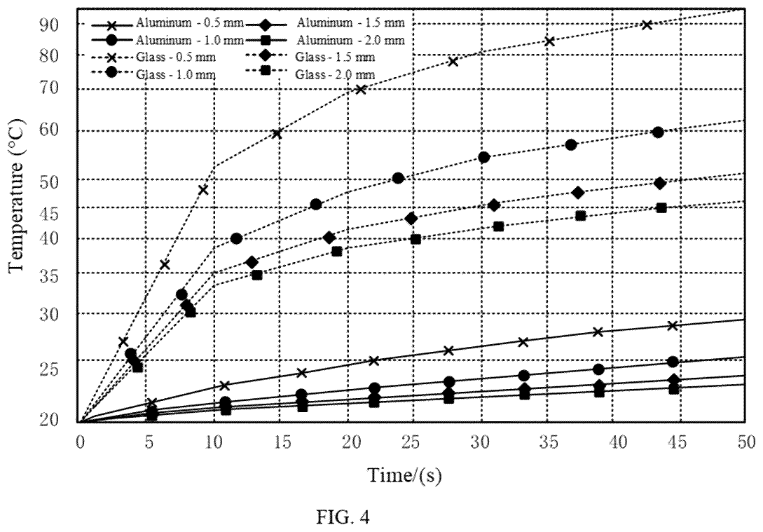

According to the embodiments of the present disclosure, simulation experiments are conducted to verify the impact of material thickness on heat dissipation. The verification results are illustrated in FIG. 4. FIG. 4 is a simulation diagram of heat accumulation of a glass plate and aluminum plates of different thicknesses, according to some embodiments of the present disclosure. As illustrated in FIG. 4, for the same material, the greater the material thickness, the greater the temperature variation, i.e., the temperature difference Δt, and the better the heat dissipation effect.

Exemplarily, the thickness of the substrate 31 is 0.3 mm to 2.2 mm. The thicker the substrate 31 is, the better the heat dissipation effect, and simultaneously the better the support effect; however, an excessively thick substrate is not conducive to the miniaturization of the sealed projection device. A substrate of such thickness can simultaneously meet the demands for heat dissipation effect, support effect of the substrate for the reflective film 32, and miniaturization of the sealed projection device. In the related art, the thickness of the first reflector made of glass material is about 2.0 mm. Since glass is fragile, ultra-thin glass is more prone to breakage, and the cost of ultra-thin glass is higher than that of ordinary glass; moreover, the tempering process is not environmentally friendly. Therefore, compared with a glass reflector, the reflector provided according to the present disclosure has advantages in heat dissipation effect, support effect for the reflective film 32, miniaturization of the sealed projection device, cost, and environmental protection.

In the embodiments of the present disclosure, the reflective film 32 includes a base material and a plurality of dielectric layers 320 stacked in sequence on the base material, and at least two of the plurality of dielectric layers 320 have different refractive indices. The embodiments of the present disclosure do not limit the number, material, or thickness of the dielectric layers. For example, a reflective film including about 1000 dielectric layers may be used. In some embodiments, the base material is made of polyethylene terephthalate (PET).

The reflective film is also referred to as an enhanced specular reflector (ESR). When light is incident on a surface of the ESR, the light entering the ESR undergoes multiple refractions and reflections among the plurality of optical thin films, making it difficult to pass through the ESR, and is ultimately reflected. The reflectivity of ESR is as high as over 98%, which is higher than the reflectivity of a commonly used reflector made of a glass material (about 95%). Moreover, ESR can be attached to the surface of any flat object.

Exemplarily, the thickness of the reflective film 32 is 60 μm to 120 μm, for example, 65 μm, 80 μm, 90 μm, or 100 μm. Reflective films of different thicknesses may be customized as needed. The thicker the reflective film, the higher the hardness and the better the rigidity, making it less prone to wrinkling during the process of attaching the reflective film 32 to the liquid crystal display panel. In some embodiments, a reflective film with a thickness of 60 μm to 80 μm is used for a 2.69-4.5 inch liquid crystal display panel; a reflective film with a thickness of 90 μm to 100 μm is used for a 4.5-7.0 inch liquid crystal display panel; and a reflective film with a thickness of 100 μm to 120 μm is used for a liquid crystal display panel larger than 7.0 inches.

In the embodiments of the present disclosure, the first reflector 3 further includes a connection layer 33, which is disposed between the substrate 31 and the reflective film 32. The connection layer 33 can adhere the reflective film 32 to the substrate 31.

Exemplarily, the connection layer 33 is an environmentally friendly grease or thermally conductive silicone grease. The two materials can not only replace glue to adhere the reflective film 32 to the substrate 31, which is beneficial to environmental protection, but also further alleviate the heat dissipation problem. Here, the environmentally friendly grease is a grease that contains thermally conductive particles and a thermally conductive gel, such as silver grease, ceramic grease, carbon grease, and nano-diamond grease.

Referring again to FIG. 1, exemplarily, the light source assembly 2 includes a light-emitting device 21 and a condensing element 22. The condensing element 22 is configured to converge the light emitted by the light-emitting device 21. The light source assembly has a simple structure and a low cost. In some embodiments, the light-emitting device 21 includes, but is not limited to, an LED. In some embodiments, the condensing element 22 is a convex lens, a condensing cup, or the like.

In some embodiments, the sealed projection device further includes a second reflector 6. The second reflector 6 is configured to reflect the light emitted from the spatial light modulator to the lens assembly 5. The arrangement of the second reflector facilitates a flexible arrangement of the lens assembly relative to the spatial light modulator.

The embodiments of the present disclosure do not limit the number of second reflectors 6, and the second reflectors may be arranged as needed.

In some embodiments, the shape of the first reflector 3 or the second reflector 6 is polygonal or circular.

Exemplarily, the lens assembly 5 includes one or more lenses. In some embodiments, the lens assembly has a focusing function.

In some embodiments, the sealed projection device further includes a first Fresnel lens 7 and a second Fresnel lens 8. The first Fresnel lens 7 and the second Fresnel lens 8 are respectively disposed on both sides of the liquid crystal display panel 4 along the propagation path of the light beam emitted by the light source assembly 2. For example, the first Fresnel lens 7 is disposed on one side, proximal to the first reflector 3, of the liquid crystal display panel 4, and the second Fresnel lens 8 is disposed on one side, proximal to the second reflector 6, of the liquid crystal display panel 4.

The first Fresnel lens 7 is configured to collimate a received light and emit the collimated light to the liquid crystal display panel 4, which can improve the brightness around the liquid crystal display panel and enhance the uniformity of brightness across the projected image. The second Fresnel lens 8 is configured to focus the light emitted from the liquid crystal display panel 4, thereby improving the overall display brightness. Moreover, compared to other types of lenses, Fresnel lenses are thin and lightweight, which is conducive to the miniaturization of the sealed projection device.

In some embodiments, the first Fresnel lens or the second Fresnel lens includes a lens body, a central protruding part, and a plurality of annular protrusions. The central protruding part and the plurality of annular protrusions are arranged on one side of the lens body, the plurality of annular protrusions surround the central protruding part and are arranged radially along the lens body, and the other side of the first Fresnel lens or the second Fresnel lens is planar. The texture of the Fresnel lens can be designed based on the requirements of light interference, diffraction, relative sensitivity, and reception angle. The principle is that the refractive power of a lens only occurs at the optical surface, such as the lens surface. By removing as much optical material as possible while retaining the curvature of the surface, a Fresnel lens is formed.

In some embodiments, the first Fresnel lens or the second Fresnel lens is made of polymethyl methacrylate (PMMA).

In some embodiments, the sealed projection device further includes a thermal insulation layer 9. The thermal insulation layer 9 is disposed between the spatial light modulator and the first Fresnel lens 7. The thermal insulation layer is conducive to lowering the temperature at the spatial light modulator and can serve to protect the spatial light modulator.

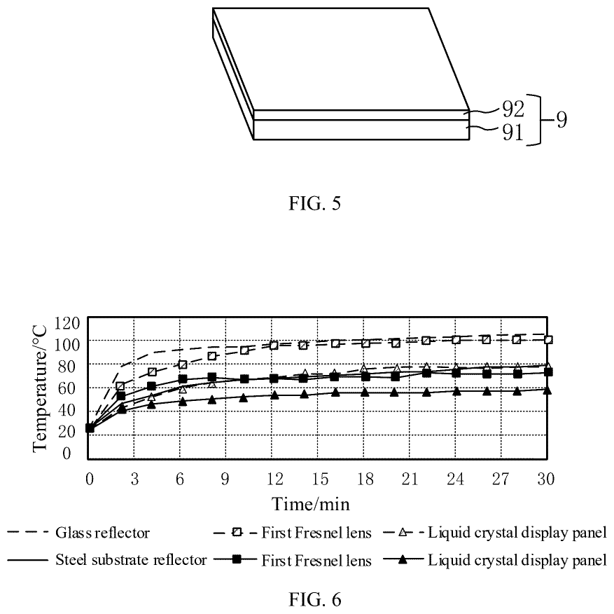

In some embodiments, the thermal insulation layer 9 includes a glass substrate 91 and at least one thermal insulation film 92, and the at least one thermal insulation film 92 is disposed on one side, distal to the spatial light modulator 4, of the glass substrate 91. The at least one thermal insulation film 92 is formed on the surface of the glass substrate 91 by vacuum evaporation. FIG. 5 is a schematic structural diagram of a thermal insulation layer according to some embodiments of the present disclosure. As illustrated in FIG. 5, the thermal insulation layer 9 includes a glass substrate 91 and a thermal insulation film 92.

In some embodiments, the thermal insulation film 92 is made of a metal, an alloy, or a metal compound material, for example, silver (Ag), aluminum (Al), tungsten (W), magnesium (Mg), molybdenum (Mo), zinc (Zn), tin (Sn), indium (In), chromium (Cr), antimony (Sb), titanium (Ti), nickel (Ni), copper (Cu), vanadium (V), cobalt (Co), iron (Fe), and niobium (Nb), or silver oxide (Ag₂O), aluminum oxide (Al₂O₃), tungsten oxide (WO₂ or WO₃), magnesium oxide (MgO), molybdenum oxide (MoO₃), zinc oxide (ZnO), tin oxide (SnO₂), indium oxide (In₂O₃), chromium oxide (CrO₃ or Cr₂O₃), antimony oxide (Sb₂O₃ or Sb₂O₅), titanium oxide (TiO₂), nickel oxide (NiO), copper oxide (CuO or Cu₂O), vanadium oxide (V₂O₃ or V₂O₅), cobalt oxide (CoO), iron oxide (Fe₂O₃ or Fe₃O₄), niobium oxide (Nb₂O₅), indium tin oxide (ITO), aluminum zinc oxide (AZO), and tin antimony oxide (ATO).

In some embodiments, the thermal insulation layer 9 further includes a polarizer. The polarizer is disposed on one side, proximal to the liquid crystal display panel, of the glass substrate 91. The polarizer can not only provide thermal insulation and protection of the liquid crystal display panel, but also provide polarized light to the liquid crystal display panel for imaging. In some embodiments, the polarizer is made of a PET material.

In the embodiments of the present disclosure, the first Fresnel lens 7, the thermal insulation layer 9, the liquid crystal display panel, and the second Fresnel lens 8 are arranged in parallel, with certain gaps provided between each pair. The gaps can provide heat dissipation channels, which are conducive to improving the heat dissipation effect.

Under the same test conditions, that is, under conditions where all other components except the first reflector, such as the light source assembly and the first Fresnel lens, are identical, the temperatures at the first Fresnel lens 7 and the liquid crystal display panel were actually measured when the first reflector is a steel substrate with a reflective film or a glass reflector. The measurement results are illustrated in FIG. 6. FIG. 6 illustrates temperature-operating time curves at a first Fresnel lens and a liquid crystal display panel when a reflector made of a 1.00 mm-thick steel substrate with an ESR reflective film and a glass reflector are each used as a first reflector, according to some embodiments of the present disclosure. As illustrated in FIG. 6, in the case that the first reflector 3 is changed from a glass reflector to a reflector, which is a steel substrate with a reflective film, after the components' temperatures become stable after operating for a period of time, the temperature at the first Fresnel lens 7 decreases by about 25° C., and the temperature at the liquid crystal display panel decreases by about 20° C., which indicates a significant improvement in heat dissipation.

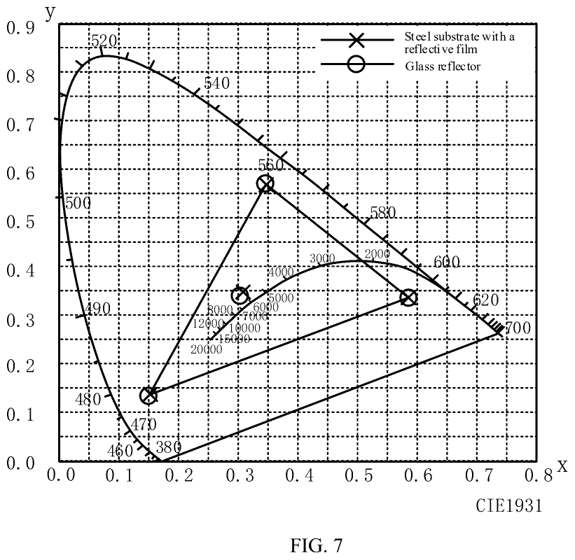

Under the same test conditions, that is, under conditions where all other components except the first reflector, such as the light source assembly and the first Fresnel lens, are identical, the image brightness, color points, and color gamut were tested by using a glass reflector and a steel substrate with an ESR reflective film separately as the first reflector. The test results are shown in Table 1 and FIG. 7. FIG. 7 is a measurement result diagram of color coordinates and color temperatures of a sealed projection device when a first reflector is made of different materials, according to some embodiments of the present disclosure. Table 1 shows the measurement results of color coordinates, brightness, color temperature, and nine-point uniformity of the sealed projection device using first reflectors made of different materials, according to some embodiments of the present disclosure. As illustrated in FIG. 7 and Table 1, in the case that a reflector made of a steel substrate and a reflective film is used as the first reflector, the color coordinates for white, red, green, and blue are (0.3022, 0.3503), (0.5859, 0.3419), (0.3461, 0.5755), and (0.1541, 0.1429), respectively, while in the case that a glass reflector is used as the first reflector, the color coordinates for white, red, green, and blue are (0.2970, 0.3452), (0.5837, 0.3417), (0.3431, 0.5752), and (0.1532, 0.1387), respectively. It can be seen that when the reflector made of a steel substrate and a reflective film is used as the first reflector, the color coordinates of each color are very close to those when the glass reflector is used as the first reflector. In FIG. 7, the point on the Planckian locus closest to the white color coordinate represents the color temperature. Therefore, the color temperature when using a glass reflector as the first reflector is very close to that when using a reflector made of a steel substrate and a reflective film as the first reflector. According to Table 1, the color temperatures are 7252K and 7005K, respectively. The color gamut is the ratio of the area of the triangle formed by a set of red, green, and blue color coordinates to the total area of the horseshoe-shaped chromaticity diagram. Therefore, the color gamuts of the two are similar. According to Table 1, the measured color gamuts for the two are both 47%.

Therefore, the first reflector provided according to the embodiments of the present disclosure alleviates the heat dissipation problem without affecting the color points and color gamut of the projected image; moreover, the brightness (the brightness value corresponding to white) is increased from 92 Ev to 105 Ev, an increase of over 10%. The thickness of the steel substrate is 1 mm, the reflective film is an ESR reflective film, and the thickness of the reflective film is about 80 μm.

In addition, the measurement result for the nine-point uniformity reflects the uniformity of the projected image brightness. As shown by the results in Table 1, replacing the material of the first reflector has little effect on the uniformity of the projected image brightness.

TABLE 1
Measurement results of color coordinates, brightness, color
temperature, and nine-point uniformity of a sealed projection
device using first reflectors made of different materials,
according to some embodiments of the present disclosure

| | | | | Reflector made of | | |
|---|---|---|---|---|---|---|
| | | | | a steel substrate | | |
| | Glass reflector | | | and a reflective film | | |
| | Bright- | Color | Color | Bright- | Color | Color |
| | ness | coordi- | coordi- | ness | coordi- | coordi- |
| Test item | Ev | nate x | nate y | Ev | nate x | nate y |
| White | 92 | 0.2970 | 0.3452 | 105 | 0.3022 | 0.3503 |
| Red | 16 | 0.5837 | 0.3417 | 20 | 0.5859 | 0.3419 |
| Green | 67 | 0.3431 | 0.5752 | 72 | 0.3461 | 0.5755 |
| Blue | 18 | 0.1532 | 0.1387 | 19 | 0.1541 | 0.1429 |
| Black | 0.1 | | | 0.1 | | |
| Color | 7257 K | | | 7005 K | | |
| temperature | | | | | | |
| T | | | | | | |
| Nine-point | 60% | | | 62% | | |
| uniformity | | | | | | |
| Color | 47% | | | 47% | | |
| gamut | | | | | | |

| | |
|---|---|
| Note | The size of the test image is 60 inches. |

Described above are merely optional embodiments of the present disclosure and are not intended to limit the present disclosure. Any modifications, equivalent substitutions, improvements, and the like, made within the spirit and principle of the present disclosure, should be included in the protection scope of the present disclosure.

1. A sealed projection device, comprising a housing, a light source assembly, a first reflector, a spatial light modulator, and a lens assembly, wherein
the light source assembly, the first reflector, the spatial light modulator, and the lens assembly are all disposed inside the housing, and the first reflector, the spatial light modulator, and the lens assembly are sequentially disposed on a propagation path of a light beam emitted by the light source assembly; and
the first reflector comprises a substrate and a reflective film that are stacked, with thermal conductivity of the substrate being greater than thermal conductivity of glass.

2. The sealed projection device according to claim 1, wherein the substrate is made of a metal material.

3. The sealed projection device according to claim 2, wherein the metal material is steel, aluminum, or copper.

4. The sealed projection device according to claim 3, wherein a thickness of the substrate is 0.3 mm to 2.2 mm.

5. The sealed projection device according to claim 1, wherein the reflective film comprises a plurality of dielectric layers stacked in sequence, wherein the plurality of dielectric layers comprise a first dielectric layer and a second dielectric layer, a refractive index of the first dielectric layer being different from a refractive index of the second dielectric layer.

6. The sealed projection device according to claim 5, wherein a thickness of the reflective film is 60 μm to 120 μm.

7. The sealed projection device according to claim 1, wherein the first reflector further comprises a connection layer, the connection layer being disposed between the substrate and the reflective film.

8. The sealed projection device according to claim 7, wherein the connection layer is environmentally friendly grease.

9. The sealed projection device according to claim 1, wherein the spatial light modulator comprises a liquid crystal display panel.

10. The sealed projection device according to claim 9, further comprising a first Fresnel lens and a second Fresnel lens, wherein the first Fresnel lens and the second Fresnel lens are respectively disposed on both sides of the spatial light modulator along the propagation path.

11. The sealed projection device according to claim 10, further comprising a thermal insulation layer, wherein the thermal insulation layer is disposed between the spatial light modulator and the first Fresnel lens, and the first Fresnel lens is disposed on one side, proximal to the first reflector, of the spatial light modulator.

12. The sealed projection device according to claim 11, wherein the thermal insulation layer comprises a glass substrate and at least one thermal insulation film, wherein the at least one thermal insulation film is disposed on one side, distal to the spatial light modulator, of the glass substrate.

13. The sealed projection device according to claim 12, wherein the thermal insulation film is made of metal, alloy, or metal compound material.

14. The sealed projection device according to claim 1, wherein the light source assembly comprises a light-emitting device and a condensing element, wherein the condensing element is configured to converge light emitted by the light-emitting device.

15. The sealed projection device according to claim 1, further comprising a second reflector, wherein the second reflector is configured to reflect light emitted from the spatial light modulator to the lens assembly.

16. The sealed projection device according to claim 1, wherein the substrate is made of a graphene material.

17. The sealed projection device according to claim 7, wherein the connection layer is thermally conductive silicone grease.
